(19) United States
(12) Patent Application Publication
(10) Pub. No.: US 2013/0175120 A1
(43) Pub. Date: Jul. 11, 2013

(54) RESIDENTIAL ELEVATOR

(71) Applicant: ThyssenKrupp Access Manufacturing, LLC, Roanoke, IL (US)

(72) Inventors: Michael Bray, Grandview, MO (US); Rick Reysen, Roanoke, IL (US)

(73) Assignee: THYSSENKRUPP ACCESS MANUFACTURING, LLC, Roanoke, IL (US)

(21) Appl. No.: 13/735,654

(22) Filed: Jan. 7, 2013

Related U.S. Application Data
(60) Provisional application No. 61/583,919, filed on Jan. 6, 2012.

(51) Int. Cl. B66B 5/18

(52) U.S. Cl. CPC B66B 5/18
USPC 187/359

(57) ABSTRACT

A modular brake block design is combined with a translational actuator and a pivotally mounted braking assembly to produce an improved braking assembly for a residential elevator. The residential elevator of the present invention also makes use of support arms which are cantilevered into a plurality of vertical slots within the elevator carriage assembly to reduce the weight of the elevator and make final assembly easier for the end user. In this way, the residential elevator is less expensive to manufacture and transport, while further being easier to install and maintain.

### CROSS-REFERENCE TO RELATED APPLICATIONS

This application claims priority of U.S. Provisional Application 61/583,919 filed Jan. 6, 2012, the contents of which are incorporated herein by reference.

### FIELD OF THE INVENTION

The present invention relates to elevators, particularly those used in residential buildings.

### BACKGROUND OF THE INVENTION

Residential elevators typically operate between two to three floors and are designed for personal, rather than commercial, use. These elevators often operate by moving a carriage assembly along guide rails using a cable or hydraulic lift system. An elevator car is secured to the carriage assembly and provides a compartment for passengers. Carriage assemblies typically have vertical support members that move along the guide rails and a support structure to secure the elevator car to the carriage assembly.

As with other elevators, residential elevators usually have an emergency braking system that prevents the elevator from falling down the guide rails in the event of a failure. Many of these braking systems are designed using a mechanical fail safe that frictionally locks the carriage assembly to the guide rails when a failure is detected with the elevator lifting system. Many designs exist using springs and other normally engaged safety systems to ensure that in the event of a failure in the lifting system, the carriage will not fall down the guide rails. These systems have to be actively disengaged by another, often hydraulic or electronic, system to allow the carriage assembly to move. Furthermore, these emergency brake systems often operate using rotational means to engage the guide rails or the lifting system. Separate emergency brake systems add to the overall cost and complexity of residential elevators and, as such, it would be beneficial for a residential elevator to make use of an emergency braking system that does not prohibitively impact the cost and reliability of the residential elevator. It would also be beneficial if the emergency braking system of the residential elevator could make use of the lifting system to control the engagement and disengagement of the emergency brake to reduce the complexity and improve the performance of the emergency braking system.

Many residential elevator components are also one sided, meaning they are designed to be used on only one side of the elevator and are not interchangeable between the two sides. This lack of interchangeability increases the overall cost of manufacturing the residential elevator and further complicates the installation at an individual residence. In many traditional emergency braking systems, the guide rails are fed through the emergency brakes during installation and assembly of the residential elevator. This type of emergency braking system not only complicates the installation of the residential elevator but also makes future maintenance procedures more difficult by requiring the carriage assembly to be removed from the guide rails. As such, it would be desirable for the emergency braking system of the residential elevator to make use of a modular design where the brakes may be installed around the guide rails and on either side of the elevator making the elevator more cost effective, simpler to install, and easier to maintain.

Residential elevators are also usually preassembled at a manufacturing facility prior to being shipped to an individual residence where the installation is completed on site. As much of the residential elevator is shipped to the end user preassembled, it would be beneficial to minimize the preassembled size of the residential elevator without unduly increasing the cost and difficulty of final installation at the residence of the end user. Furthermore, reducing the overall weight of the residential elevator will help keep shipping costs down while also making final installation easier.

### SUMMARY OF THE INVENTION

In accordance with the invention, a modular brake block design is combined with a translational actuator and a pivotally mounted braking assembly to produce an improved braking assembly for a residential elevator. The residential elevator of the present invention also makes use of support arms which are cantilevered into a plurality of vertical slots within the elevator carriage assembly to reduce the weight of the elevator and make final assembly easier for the end user. In this way, the residential elevator is less expensive to manufacture and transport, while further being easier to install and maintain.

The elevator carriage assembly and the elevator car are moved along a pair of guide rails by a lifting system. The carriage assembly has a pair of spaced apart vertical support members and a plurality of support arms at a bottom end of the vertical support members extending perpendicularly out from the vertical support members. A pair of spaced apart brake blocks are mounted on the exterior side of the vertical support members so that the brake blocks are bounding the guide rail. An actuator having an open or unlocked position and a locked position extends between the vertical support members and connects the carriage assembly to the lifting system. A braking assembly is connected to the actuator and pivotally mounted on one of the brake blocks so that when the actuator is in the locked position the braking assembly engages the brake block and the guide rail to prevent the carriage assembly from moving down along the guide rail. The actuator is biased in the locked position such that the normal operating weight of the elevator overcomes the bias and moves the actuator, along with the braking assembly, into the open or unlocked position.

A pair of brake blocks are spaced apart from one another and mounted on the exterior of the vertical support member. Using screws, bolts, or other known fixing means, the brake blocks are secured through the vertical support member to a brake plate on the interior side of the vertical support member. The brake blocks have a generally rectangular shape and are spaced apart to allow the guide rail to pass therebetween. An upper side of at least one of the brake blocks is angled towards the guide rail such that the distance between the brake blocks decreases in a vertically upward direction.

A braking assembly is mounted to one of the brake blocks and extends into the space between the two brake blocks. The braking assembly is pivotally movable between a downward open or unlocked position and an upward locked position. The braking assembly resides between the brake block and the guide rail. Due to the angling of the brake block, when the braking assembly is in the downward open or unlocked position, the carriage assembly may freely move along the guide rail. However, when moved into the upward locked position, the braking assembly forcibly engages the guide rail between the brake blocks to prevent the carriage assembly from moving in a vertically downward direction. The angling of the brake block along with the pivoting movement of the braking assembly translates the downward force generated by the weight of the carriage assembly into a frictional braking force on the guide rail.

The braking assembly is moved between the downward open or unlocked position and the upward locked position by the actuator. The actuator extends between the vertical support members and is mechanically connected to the braking assembly. The actuator is also connected to the lifting system and to the vertical support members. The actuator is movable between a locked position where the carriage assembly is prevented from traveling in a vertically downward direction by the braking assembly and an open or unlocked position in which the carriage assembly may freely move up and down the guide rails. A biasing member biases the actuator vertically downward into the locked position such that in the event of a lifting system failure the carriage assembly will be prevented from traveling in a downward direction. However, under normal operating conditions, the operating weight of the elevator is translated through the lifting system to the actuator which overcomes the biasing member and moves the actuator into the open position so that the carriage assembly may freely move up and down the guide rails.

The elevator car is supported on its underside by a plurality of support arms that extend perpendicularly outwards from the vertical support members. The support arms are disposed within vertical slots within the vertical support members and are cantilevered into place. Once inserted into the vertical slots of the vertical support members, the support arms are fixedly held in place by a plurality of spacing locks disposed between the individual support arms. The spacing locks have a pair of angled slots such that a downward vertical force applied to the spacing locks is translated into a horizontal locking force that wedges the spacing locks between adjacent support arms thereby locking the support arms within the vertical slots of the vertical support members. These cantilevered support arms and spacing locks are easier to install on site and further reduce the cost of shipping and manufacturing the residential elevator.

The elevator carriage assembly further features a plurality of guide wheels mounted on the exterior side of the vertical support members. As the elevator carriage assembly moves up and down the guide rails, the guide wheels absorb bumps in the guide rails, reduce vibration in the elevator, and help to guide the elevator carriage assembly along the rails. The guide rails have at least one groove on a circumferential surface of the guide wheel that houses an o-ring. These grooved guide wheels offer performance similar to that of traditional polyethylene or neoprene covered wheels and are cheaper to manufacture and maintain.

### BRIEF DESCRIPTION OF THE DRAWINGS

A better understanding of the present invention will be had upon reference to the following detailed description when read in conjunction with the accompanying drawings, wherein like reference characters refer to like parts throughout the several views, and in which:

FIG. 1 is a perspective view illustrating a preferred embodiment of the present invention;

FIG. 2 is a perspective view illustrating the carriage assembly of the present invention;

FIG. 3 is a perspective view illustrating the braking system of the present invention in an open or unlocked position;

FIG. 4 is a perspective view illustrating the braking system of the present invention in a locked position;

FIG. 5 is a perspective view illustrating the braking assembly of the present invention in an open or unlocked position;

FIG. 6 is a perspective view illustrating the braking assembly of the present invention in a locked position; and

FIG. 7 is a perspective view illustrating a spacing lock of the present invention.

### DETAILED DESCRIPTION OF A PREFERRED EMBODIMENT OF THE PRESENT INVENTION

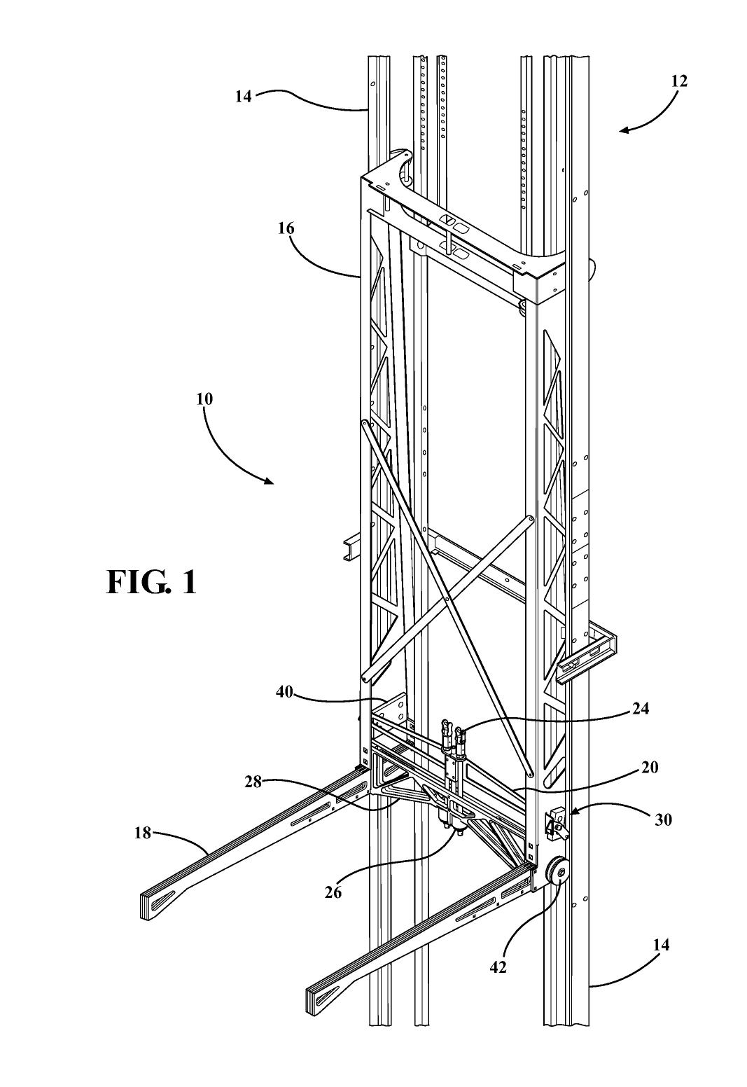

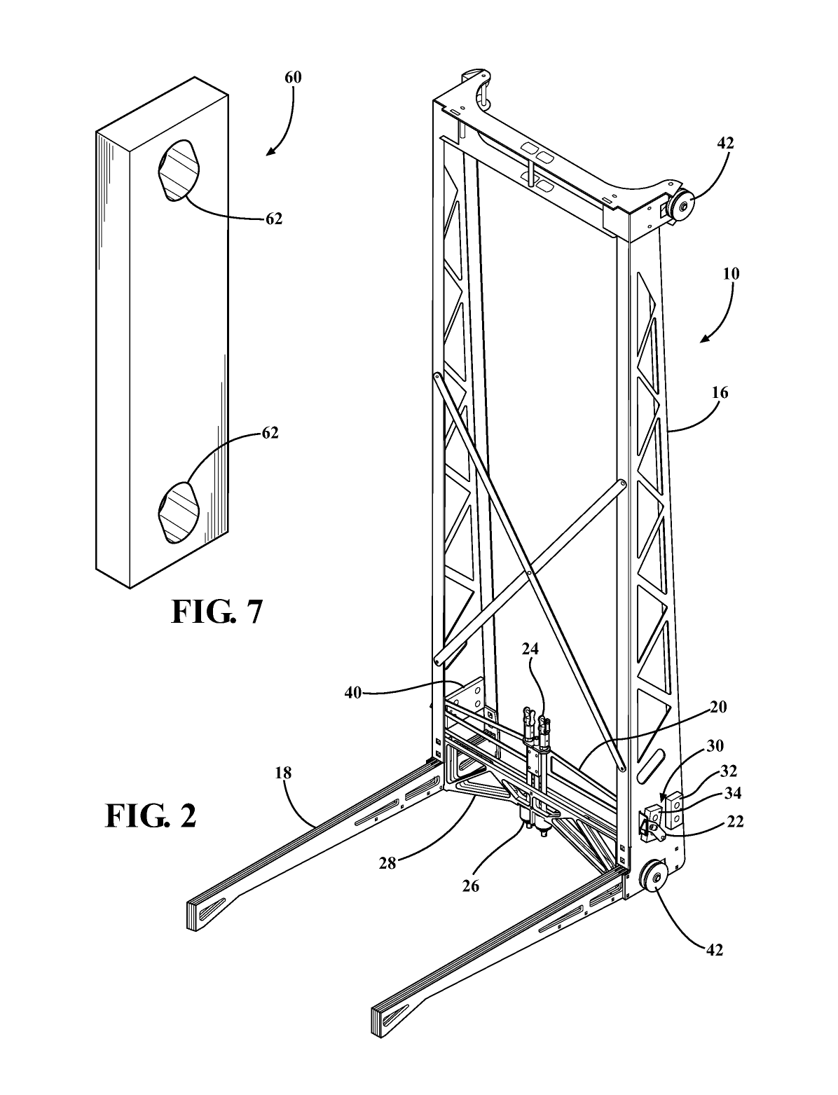

A support structure 12 for a residential elevator is generally shown in FIG. 1. The support structure 12 includes a pair of spaced apart guide rails 14, a carriage assembly 10, and a lifting system which is not shown. The guide rails 14 are mounted to the building in a vertical position. The carriage assembly 10 is moved along the guide rails 14 by the lifting system. It is also understood that a passenger car is mounted to the carriage assembly 10; however, the passenger car is not depicted herein.

The carriage assembly 10 includes a pair of spaced apart vertical support members 16, support arms 18, a braking actuator 20, a braking assembly 22, brake blocks 30, and guide wheels 42. The brake blocks 30 are spaced apart and mounted on the exterior of the vertical support members 16 so that the guide rails 14 pass between the brake blocks 30. The lifting system is connected to the carriage assembly 10 by the master links 24, which are in turn connected to the actuator 20. The actuator 20 is also connected to a biasing member 26 that biases the actuator 20 vertically downward into the locked position.

The elevator has a braking system 50 that prevents the carriage assembly 10 from falling down the guide rails 14 in the event of a failure in the lifting system. The braking system 50 is movable between an open or unlocked position and a locked position, as shown in FIGS. 3 and 4 respectively.

The top of the actuator 20 is connected to the lifting system by the master links 24 and to the carriage assembly 10 through the cross piece 28. The actuator 20 is movable in a vertical direction between a downward locked position and an upward open or unlocked position. When the actuator 20 is unloaded or disconnected from the lifting system, the biasing member 26 biases the actuator 20 vertically downward into the locked position. When the carriage assembly 10 is loaded the weight is transferred through the actuator 20 and the master links 24 to the lifting system which overcomes the bias of the biasing member 26 and moves the actuator 20 into the vertically upward open or unlocked position.

The amount of bias provided by the biasing member 26 is set such that in the event of a failure in the lifting system, the actuator 20 is moved into the vertically downward locked position which engages the braking assembly 22 and locks the carriage assembly 10 to the guide rails 14. For example, the biasing member 26 may be set so that the weight of the carriage assembly 10 and unloaded passenger car is enough to overcome the bias of the biasing member 26 and allow the carriage assembly 10 to freely travel up and down the guide rails 14. However, if there is a failure in the lifting system or the acceleration of the carriage assembly 10 in a vertically downward direction becomes too great, the biasing force from the biasing member 26 will overcome the upward force exerted on the actuator 20 through the master links 24 and move the braking assembly 22 into engagement with the brake block 30 and the guide rail 14 to stop the carriage assembly 10.

A pair of spaced apart brake blocks 30 are mounted on an exterior surface of the vertical support member 16. The brake blocks 30 are secured through the vertical support member 16 to a brake plate 40 on the interior side of the vertical support member 16. In a preferred embodiment, the brake blocks 30 are affixed to the brake plate 40 using threaded bolts although other affixing means will be apparent to those skilled in the art. This three piece brake block design 30 can be installed around the guide rail 14 and is easier to service than other braking systems that must be fed onto the guide rail 14. The brake blocks 30 themselves are also interchangeable from one side of the carriage assembly 10 to the other which makes them simpler to manufacture and more cost effective than braking systems that are designed to only work on one side of the carriage assembly 10.

The brake blocks 30 are generally rectangular in shape and have through holes 36 and a hardware mounting hole 38. The through holes 36 are used to secure the brake blocks 30 to the brake plate 40 through the vertical support member 16. A pivot wheel 54 is secured to the hardware mounting hole 38 and guides the braking assembly 22 as it moves between the locked position and the open or unlocked position.

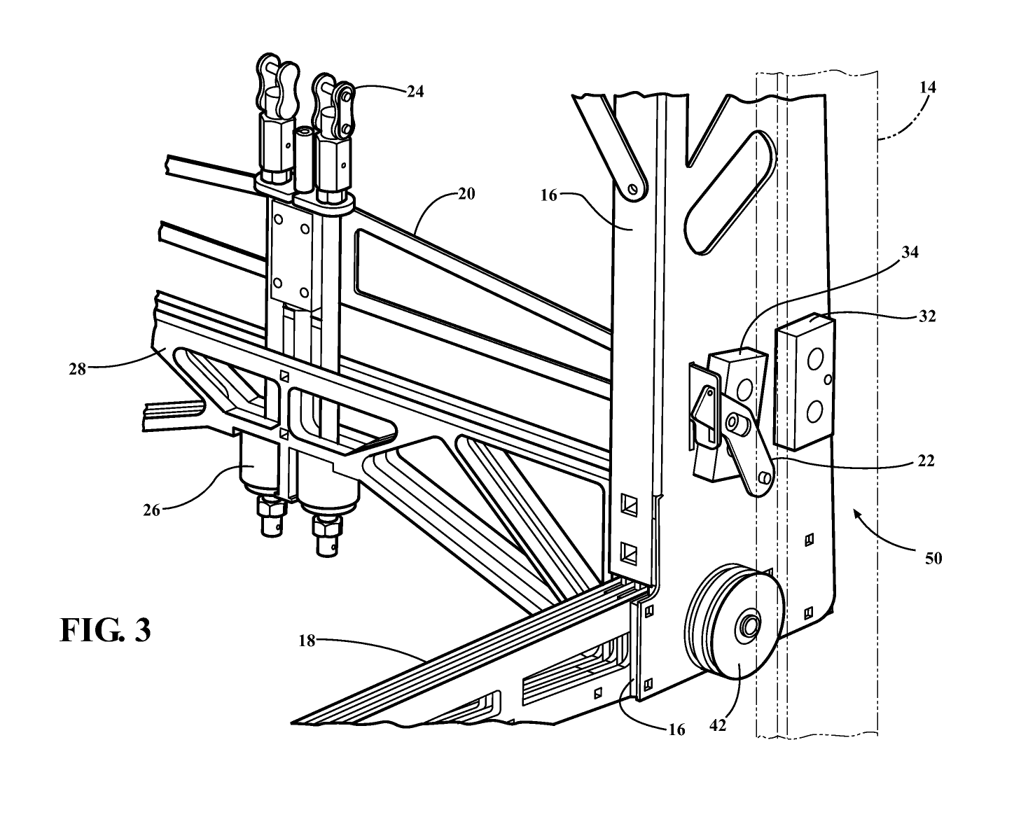

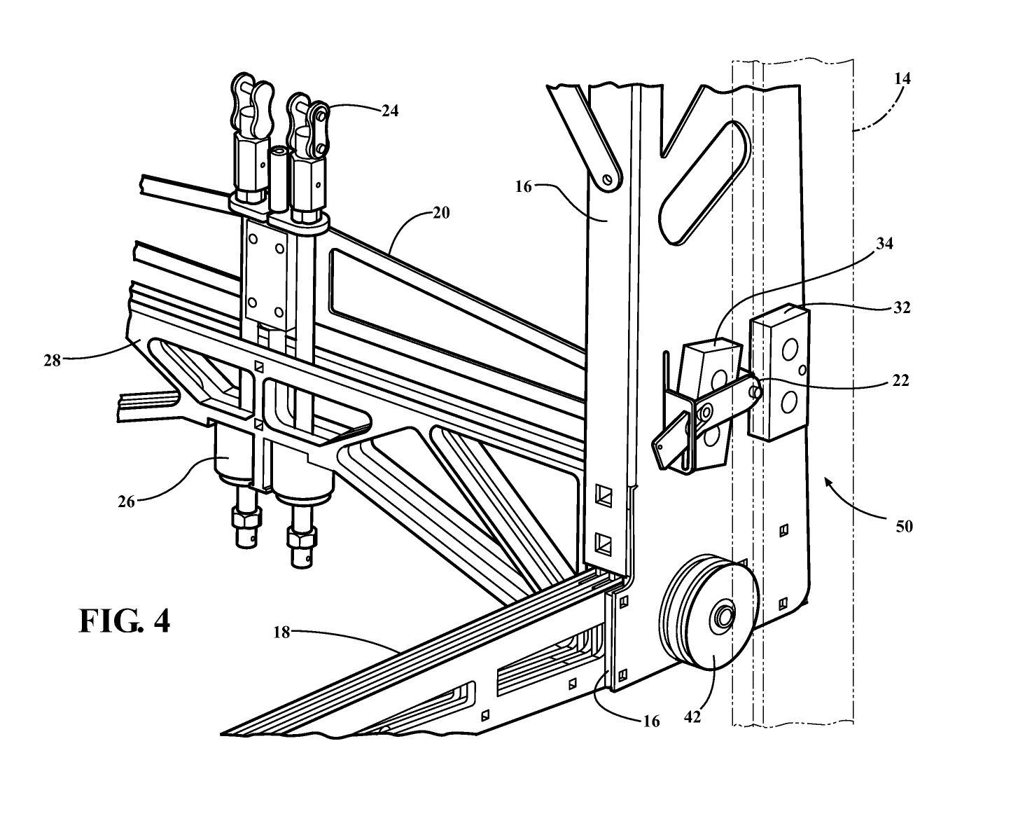

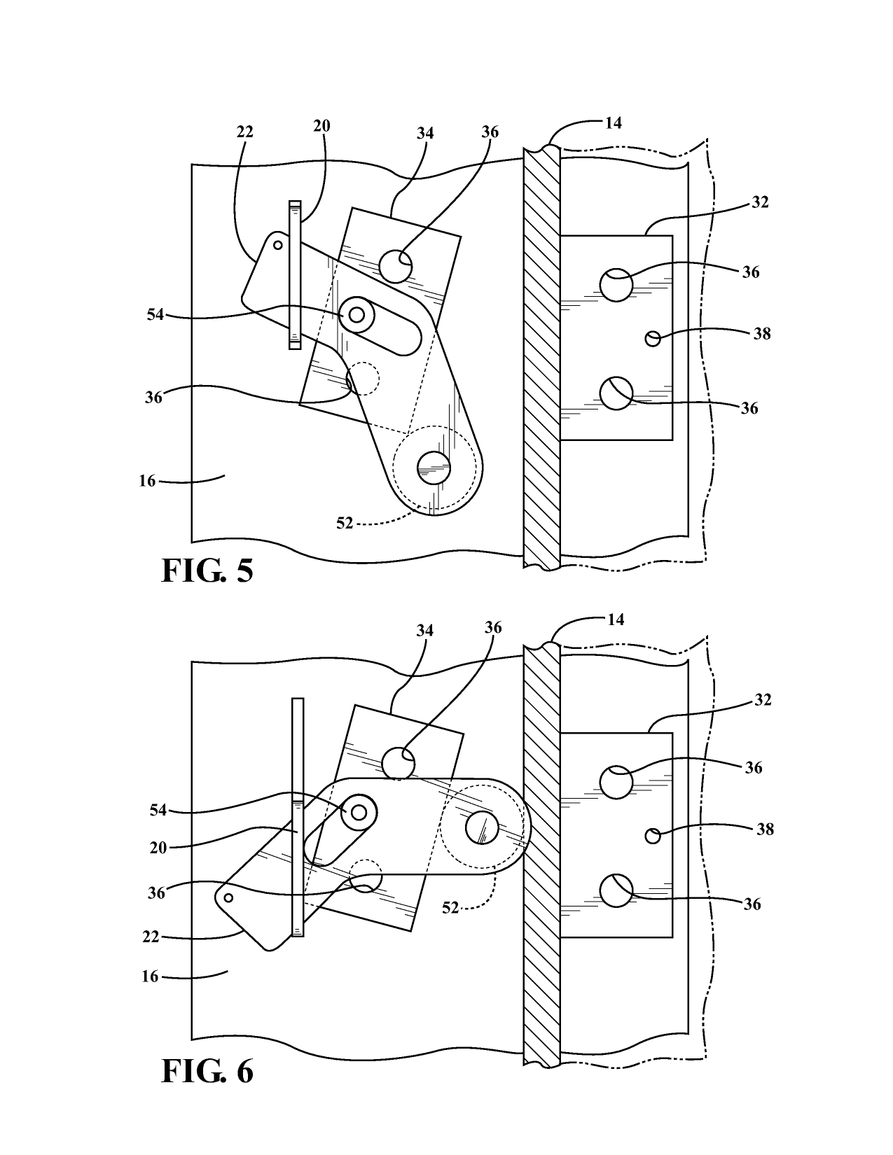

The pair of brake blocks 30 are spaced apart from one another so as to bound a portion of the guide rail 14. The interior brake block 32 is aligned in a generally vertical direction to align with the guide rail 14. The brake block 34 on the exterior side of the guide rail 14 is angled so that a top side of the exterior brake block 34 is closer to the guide rail 14 than the bottom side of the exterior brake block 34. As shown with detail in FIG. 5, when the braking assembly 22 is in the open or unlocked position, the braking assembly 22 stop is held away from the guide rail 14. This allows the carriage assembly 10 to freely move up and down the guide rail 14. When the actuator 20 moves to the vertically downward locked position, as shown in FIG. 6, the braking assembly 22 pivotally rotates upward to bring the braking assembly stop 52 into engagement with the exterior brake block 34 and the guide rail 14.

As the braking assembly stop 52 comes into engagement with the exterior brake block 34 and the guide rail 14, the angled surface of the exterior brake block 34 transfers the vertically downward force of the carriage assembly 10 into a horizontal force that presses the guide rail 14 against the interior brake block 32. In this way, the braking system 50 of the present invention does not rely on a separate braking system and instead uses the weight of the carriage assembly 10 to provide the braking force.

The carriage assembly 10 of the present invention also has guide wheels 42 mounted to the exterior side of the vertical support members 16. The guide wheels 42 absorb bumps in the guide rails 14, reduce vibration in the elevator, and help guide the carriage assembly 10 along the guide rails 14. The guide wheels 42 have grooves on a circumferential surface that house o-rings. The grooved guide wheels 42 of the present invention are more cost effective to manufacture than traditional polyethylene or neoprene covered guide wheels. Furthermore, the guide wheels 42 are more cost effective to maintain as worn out o-rings are easier and more cost effective to replace than entire polyethylene or neoprene covered wheels. In a preferred embodiment, the guide wheels 42 have two grooves along the circumferential surface of the guide wheel. The guide wheels 42 are shown at the top and bottom ends of the vertical support members 16; however, it is understood that additional wheels may be placed at different locations along the vertical support members 16.

The support arms 18 extend perpendicularly outward from the vertical support members 16 to support the passenger car. In a preferred embodiment, a plurality of support arms 18 are mounted at a bottom end of the vertical support members 16. The vertical support members 16 have a plurality of spaced apart vertical slots into which the support arms 18 are cantilevered into engagement with the vertical support members 16. When the support arms 18 are in the vertical slots of the vertical support members 16, spacing locks 60 are inserted between the support arms 18 to forcibly secure the support arms 18 within the vertical slots of the vertical support members 16.

The individual support arms 18 of the present invention help reduce the overall transportation cost of delivering a partially assembled residential elevator to an individual consumer. The cantilevered support arms 18 are also easier to install on site and are also easier to handle than larger solid support arms.

The spacing locks 60 have a pair of angled slots 62 that receive a pair of bolts which are used to secure the support arms 18 to the vertical support member 16. The slots 62 are angled so that when installing the support arms 18 on site, a vertically downward force applied to the spacing locks 60 forces the spacing locks 60 downward and inward towards the guide rail 14, wedging the spacing locks 60 between adjacent support arms 18. In this way, the support arms 18 are fixedly secured to the vertical support members 16 by wedging the spacing locks 60 therebetween.

From the foregoing, it can be seen that the present invention provides a residential elevator that combines a three piece brake block design 30 with a vertically biased actuator 20 to produce an improved braking system 50 for a residential elevator. The present invention also provides cantilevered support arms 18, spacing locks 60, and grooved guide wheels 42 to allow for easier on site installation while additionally reducing shipping and manufacturing costs. Having described the invention, however, many modifications thereto will become apparent to those skilled in the art to which it pertains without deviation from the spirit of the invention as defined by the scope of the appended claims.

We claim:

1. An elevator carriage assembly that is moved along a guide rail by a lifting system, the elevator carriage assembly comprising:
a frame;
an actuator connected to the frame and the lifting system, the actuator having a locked position and an open position;
a braking assembly connected to the actuator, the braking assembly engaging the guide rail when the actuator is in the locked position and the braking assembly disengaging the guide rail when the actuator is in the open position;
at least one guide wheel mounted on the exterior side of the frame, the guide wheel having at least one groove on a circumferential surface of the guide wheel, the groove housing an o-ring; and
the actuator biased in the locked position with an operating weight of the elevator moving the actuator to the open position.

2. The elevator carriage assembly of claim 1, further comprising:
a pair of spaced apart brake blocks mounted on an exterior of the frame, the brake blocks bounding the guide rail; and
the braking assembly pivotally mounted on one of the brake blocks.

3. The elevator carriage assembly of claim 1, further comprising:
a biasing member that biases the actuator into the locked position; and
the operating weight of the elevator overcoming the biasing member and moving the actuator to the open position.

4. The elevator carriage assembly of claim 3, wherein:
the biasing member biases the actuator in a vertically downward locked position.

5. The elevator carriage assembly of claim 2, further comprising:
a brake plate mounted on an interior of the frame; and
the brake blocks secured to the brake plate.

6. The elevator carriage assembly of claim 1, wherein:
the carriage assembly is prevented from moving in a vertically downward direction along the guide rail when the actuator is in the locked position.

7. The elevator carriage assembly of claim 2, further comprising:
the braking assembly engaging the guide rail and the brake block when the actuator is in the locked position and the braking assembly disengaging the guide rail and the brake block when the actuator is in the open position.

8. The elevator carriage assembly of claim 2, wherein:
an upper portion of at least one of the brake blocks is angled toward the guide rail.

9. The elevator carriage assembly of claim 1, further comprising:
the braking assembly pivotally rotating from a vertically downward position when the actuator is in the open position to a vertically upward position when the actuator moves to the locked position.

10. The elevator carriage assembly of claim 2, further comprising:
the frame having a pair of spaced apart vertical support members, the vertical support members having exterior and facing interior sides; and
the actuator extending between the facing interior sides of the vertical support members.

11. The elevator carriage assembly of claim 10, further comprising:
at least one brake plate mounted on at least one facing interior side of the vertical support members; and
the brake blocks secured to the brake plate.

12. An elevator carriage assembly that is moved along a pair of spaced apart guide rails by a lifting system, the elevator carriage assembly comprising:
a pair of spaced apart vertical support members that move along the guide rails, the vertical support members having exterior sides and facing interior sides;
a plurality of support arms at a bottom end of the vertical support members, the support arms extending perpendicularly from the vertical support members;
an actuator connected to the vertical support members and the lifting system, the actuator extending between the facing interior sides of the vertical support members, and the actuator having a locked position and an open position;
a braking assembly connected to the actuator, the braking assembly engaging the guide rail when the actuator is in the locked position and the braking assembly disengaging the guide rail when the actuator is in the open position;
at least one guide wheel mounted on the exterior side of at least one vertical support member;
at least one groove on a circumferential surface of the guide wheel, the groove housing an o-ring; and
the actuator biased in the locked position with an operating weight of the elevator moving the actuator to the open position.

13. The elevator carriage assembly of claim 12, further comprising:
a pair of spaced apart brake blocks mounted on the exterior side of at least one of the vertical support members, the brake blocks bounding the guide rail; and
the braking assembly pivotally mounted on one of the brake blocks.

14. The elevator carriage assembly of claim 12, further comprising:
a biasing member that biases the actuator vertically downward in the locked position; and
the operating weight of the elevator overcoming the biasing member and moving the actuator to the open position.

15. The elevator carriage assembly of claim 13, further comprising:
a brake plate mounted on the facing interior side of at least one of the vertical support members; and
the brake blocks secured to the brake plate.

16. The elevator carriage assembly of claim 13, further comprising:
the braking assembly engaging the guide rail and the brake block when the actuator is in the locked position, the braking assembly disengaging the guide rail and the brake block when the actuator is in the open position, the braking assembly pivotally rotating from a vertically downward position when the actuator is in the open position to a vertically upward position when the actuator moves to the locked position; and
the carriage assembly is prevented from moving in a vertically downward direction along the guide rails when the actuator is in the locked position.

17. The elevator carriage assembly of claim 13, wherein:
an upper portion of at least one of the brake blocks is angled toward the guide rail.

18. The elevator carriage assembly of claim 12, further comprising:
the vertical support members having a plurality of spaced apart vertical slots; and
the support arms disposed within the vertical slots and cantilevered into engagement with the vertical support members.

19. The elevator carriage assembly of claim 12, further comprising:
a plurality of spacing locks disposed between the plurality of support arms, the spacing locks having a pair of angled slots such that a downward vertical force applied to the spacing locks is translated into a horizontal locking force that fixedly engages the support arms.
